(19) United States
(12) Patent Application Publication
(10) Pub. No.: US 2020/0333148 A1
(43) Pub. Date: Oct. 22, 2020

(54) LONG-RANGE NAVIGATION PLANNING AND CHARGING STRATEGY FOR ELECTRIC VEHICLES

(71) Applicant: Ford Global Technologies, LLC, Dearborn, MI (US)

(72) Inventors: Shiqi QIU, Canton, MI (US); Xianzhi GONG, Novi, MI (US); Jun LONG, Canton, MI (US); Qi DAI, Dearborn, MI (US)

(21) Appl. No.: 16/386,895

(22) Filed: Apr. 17, 2019

(51) Int. Cl. G01C 21/34

(52) U.S. Cl. CPC G01C 21/3446; G01C 21/3476; G01C 21/3469

(57) ABSTRACT

Electrified vehicle including a vehicle battery, and a processor configured to receive map data and generate a route based on the map data, and in response to a required vehicle energy needed to complete the route exceeding the current vehicle energy, modify the route to include at least one charging stop, wherein the at least one charge stop includes: a first number of shorter charging stops for recharging the battery at a first rate to a first state of charge less than a maximum state of charge, and a second number of longer charging stops for recharging the battery at a second rate to a second state of charge higher than the first state of charge, wherein the first rate is faster than the second rate and the first and second number of charging stops are selected to minimize combined charging time of the at least one charging stop.

### TECHNICAL FIELD

Aspects of the disclosure generally relate to long-range navigation planning and charging strategy for electric vehicles.

### BACKGROUND

Electric vehicles are becoming more and more popular. With the increased availability of charging stations, drivers are willing to take their vehicles on longer routes, recharging the vehicle batteries along the route. However, more optimal charging strategies may be appreciated by drivers.

### SUMMARY

An electrified vehicle may include a vehicle battery, and a processor configured to receive map data and generate a route based on the map data, and in response to a required vehicle energy needed to complete the route exceeding the current vehicle energy, modify the route to include at least one charging stop, wherein the at least one charge stop includes: a first number of shorter charging stops for recharging the battery at a first rate to a first state of charge less than a maximum state of charge, and a second number of longer charging stops for recharging the battery at a second rate to a second state of charge higher than the first state of charge, wherein the first rate is faster than the second rate and the first and second number of charging stops are selected to minimize combined charging time of the at least one charging stop.

A long-range navigation system for an electric vehicle may include a memory, and a processor configured to receive map data and generate a route based on the map data, the route associated with a calculated required energy needed to complete the route, and in response to the required energy exceeding a current vehicle energy, modify the route to include at least one charging stop to allow for recharging of a vehicle battery at a first rate, the first rate including a charge rate up to a threshold battery state of charge where the charge rate begins to decrease.

A method for recharging an electric vehicle along a route may receiving map data and generate a route based on the map data, and modifying, in response to a required energy required for completing the route exceeding a current energy, the route to include at least one charging stop along the route, the charging stop including at least one of a shorter charging stop for recharging of a vehicle battery at a first rate of charge less than a maximum state of charge and a second rate to a second state of charge higher than the first state of charge.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates an example diagram including a vehicle having a long-range navigation system for electric vehicles;

FIG. 2 illustrates an example route generated by the long-range navigation system;

FIG. 3 illustrates an example graph showing the time to charge (minutes) versus the rate of charge (kW);

FIG. 4 illustrates an example graph showing current (A) and SOC (%) versus time (minutes) for an example charging strategy of one example vehicle;

FIG. 5A illustrates an example first route plan generated by the long-range navigation system;

FIG. 5B illustrates an example second route plan generated by the long-range navigation system;

FIG. 6A illustrates an example third route plan generated by the long-range navigation system;

FIG. 6B illustrates an example fourth route plan generated by the long-range navigation system; and

FIG. 7 illustrates an example process for the long-range navigation system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Disclosed herein is a long-range navigation system for electric vehicles. Often, during long trips, the required energy needed to complete the trip may exceed the current vehicle energy. This may require an electric vehicle to recharge mid-trip. In some situations, charging time to fully recharge a battery of an electric vehicle may exceed four hours. This time may depend on the type of charger being used, as well as the battery state of charge (SOC), the battery size, speed of charge, etc. In general, the charging rate is faster when the state of charge is low. The charging rate may be slower when the state of charge is high. When charging a battery to full capacity, the battery may charge quickly at first, but the rate of charge may significantly decrease towards the end of charging when the state of charge is at a high percentage (e.g., 80-90%). A large amount of down-time during a trip may be inconvenient to the driver and passengers. Shorter charging times, even if requiring more stops, may be more tolerable and preferable to the driver. In some situations, multiple shorter charging stops may take less overall time out of the trip than a single longer charging stop.

The long-range navigation system disclosed herein may optimize charging stops by determining the fastest charging plan. In some examples, one longer charge stop may be more efficient, but in others, multiple shorter charge stops may save time overall. The navigation system takes into account the charging speeds, detour times required to reach a charging station, required energy for the trip, and current vehicle energy. The navigation system may develop a route plan that optimizes the charging time and overall trip time, while meeting all required energy needs.

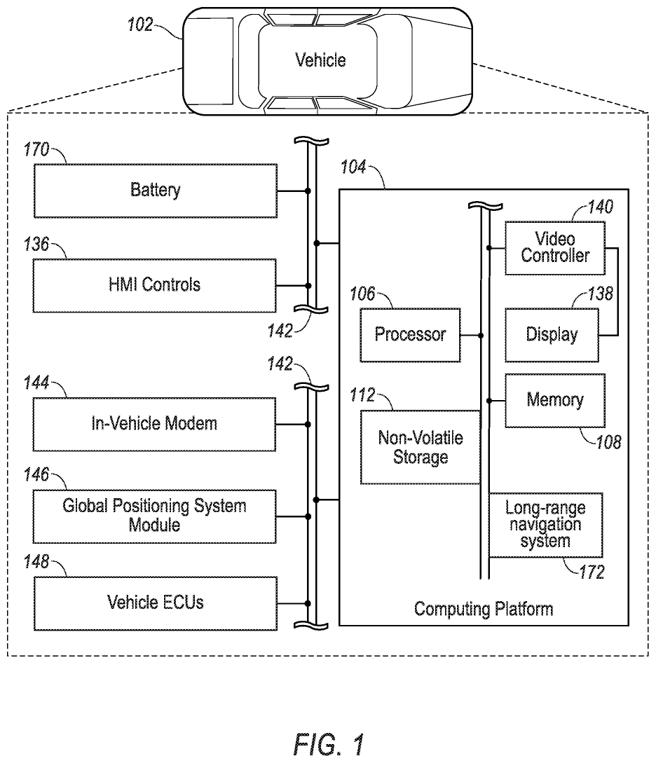

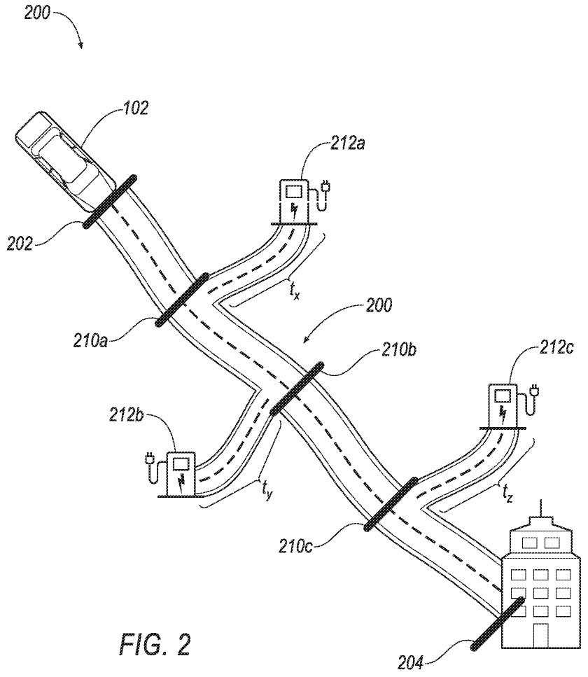

FIG. 1 illustrates an example diagram including a vehicle 102 having a long-range navigation system 172 (and further shown in FIG. 2) for vehicles. The vehicle 102 may be configured to access telematics servers and mobile devices. The vehicle 102 may include various types of passenger vehicles, such as crossover a utility vehicle (CUV), a sport utility vehicle (SUV), a truck, a recreational vehicle (RV), a boat, a plane or other mobile machine for transporting people or goods. The vehicle 102 may be an electric or electrified vehicle (EV), which includes battery electric vehicles (BEV). The vehicle 102 may also include PHEVs (plug-in hybrid electric vehicles) and hybrid electric vehicles (HEV). The vehicle 102 may be an autonomous vehicle. Telematics services may include, as some non-limiting possibilities, navigation, turn-by-turn directions, vehicle health reports, local business search, accident reporting, and hands-free calling. In an example, the vehicle 102 may include the SYNC system manufactured by The Ford Motor Company of Dearborn, Mich. It should be noted that the illustrated system is merely an example, and more, fewer, and/or differently located elements may be used.

The computing platform 104 may include one or more processors 106 configured to perform instructions, commands and other routines in support of the processes described herein. For instance, the computing platform 104 may be configured to execute instructions of vehicle applications to provide features such as navigation, accident reporting, satellite radio decoding, and hands-free calling. Such instructions and other data may be maintained in a non-volatile manner using a variety of types of computer-readable storage medium. The computer-readable medium (also referred to as a processor-readable medium or storage) includes any non-transitory medium (e.g., a tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may also receive input from human-machine interface (HMI) controls 136 configured to provide for occupant interaction with the vehicle 102. The computing platform 104 may also drive or otherwise communicate with one or more displays 138 configured to provide visual output to vehicle occupants by way of a video controller 140. In some cases, the display 138 may be configured to display state-of-charge (SOC) of the vehicle, including other information related to the stored energy of the vehicle such as trip range, battery range, etc. The display 138 may also be configured to display route information including a destination location, charge points, etc.

The computing platform 104 may be further configured to communicate with other components of the vehicle 102 via one or more in-vehicle networks 142. The in-vehicle networks 142 may include one or more of a vehicle controller area network (CAN), an Ethernet network, and a media oriented system transfer (MOST), as some examples. The in-vehicle networks 142 may allow the computing platform 104 to communicate with other vehicle 102 systems, such as a vehicle modem 144 (which may not be present in some configurations), a global positioning system (GPS) module 146 configured to provide current vehicle 102 location and heading information, and various vehicle ECUs (electronic control units) 148 configured to incorporate with the computing platform 104. As some non-limiting possibilities, the vehicle ECUs 148 may include a powertrain control module configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors and/or trunk of the vehicle 102); a radio transceiver module configured to communicate with key fobs or other local vehicle 102 devices; and a climate control management module configured to provide control and monitoring of heating and cooling system components (e.g., compressor clutch and blower fan control, temperature sensor information, etc.).

The vehicle 102 includes a battery 170. The battery 170 may include at least one high voltage (HV) battery such as a traction battery. The battery 170 may be used to power electric vehicles and provide high voltage direct current output. In addition to providing energy for propulsion, the traction battery may provide energy for other vehicle electrical systems.

The vehicle 102 may also include the long-range navigation system 172. This system may, in conjunction with the GPS module 146 and telematic systems, provide various routes to the vehicle. These routes may be based on a destination address as input by a user via the HMI controls 136. The route may include a start location and the destination location. The long-range navigation system 172 may receive the battery SOC from the battery 170, as well as fuel level from the ECUs 148. The long-range navigation system 172 may then determine whether the current vehicle energy is sufficient to complete the route. The current vehicle energy may include the distance the vehicle may travel on the current fuel energy, for vehicles having an internal combustion engine, and battery energy. In one example, the user may be prompted to select which type of energy to include, such as to only use battery power to determine the charge points or only use fuel energy. If the required energy for the route exceeds the current energy, the system 172 may identify various charge points along the route at which the vehicle battery 170 may be recharged. The location of the chart points and duration spent at each of the charge points may be optimized to achieve the shortest drive time. While the navigation system 172 is illustrated as being separate from the processor 106, the processor 106 may include or execute instructions from the navigation system 172.

FIG. 2 illustrates an example route 200. The route 200 may include a start location 202 and an end location 204. The end location 204 may be received from the user via the HMI controls 136. The end location 204 may, additionally or alternatively, be received from a mobile device associated with the user, a voice command, etc. The processor 106 may receive map data from the vehicle telematics, the memory 108, etc. The map data may provide the possible roads, stops, locations of charging stations, etc., to the navigation system 172. The processor 106 may generate the route based on the start location 202, end location 204, and map data.

Depending on the current battery SOC and fuel level indicating a distance to empty (DTE) of the vehicle, the vehicle 102 may not be able to travel the entire route without needing to recharge or refuel. If this is the case, the long-range navigation system 172 may determine certain charge points 210 where the vehicle 102 may stop along the route 200 to recharge, at least in part, the battery 170. The route 200 may include multiple charge points 210. The charge points 210 may be arranged at various points along the route 200. Although not shown, fuel stops could also be determined.

Each charge point 210 may be associated with a charging station 212. The charging stations 212 may be located within a maximum proximity (either predefined distance and/or time) to the charge point 210. In many instances, the charging stations 212 may be located at fuel stations at highway exits, etc. That is, the charging stations 212 may not be directly on the route 200, but instead, may require a detour from the route 200. The long-range navigation system 172 may determine a detour time associated with driving to the charging station 212. The detour time may depend on distance from the route 200, speed limits, traffic, etc. In the example shown in FIG. 2, a first charging point 210a is associated with a first charging station 212a having a detour time of tₓ. A second charging point 210b is associated with a second charging station 212b having a detour time of t_{y}. A third charging point 210c is associated with a third charging station 212c having a detour time oft, Notably, when calculating the entire charge time, the charging time may include both the time spent charging the battery 170 as well as the detour time. Thus, the charging time for the first charge point 210a may be:

charging time=charging segment+2(detour segment)=charging segment+2tₓ

In some examples, the route 200 may require one complete recharge of the battery 170. However, in the alternative to stopping once for a longer charge, the vehicle 102 may stop twice, but for shorter durations. The long-range navigation system 172 may take into consideration the time at each possible charge station and the charging speed at various states of charge. The charging rate of the two shorter segments may be much faster than the average charging rate of the longer segment.

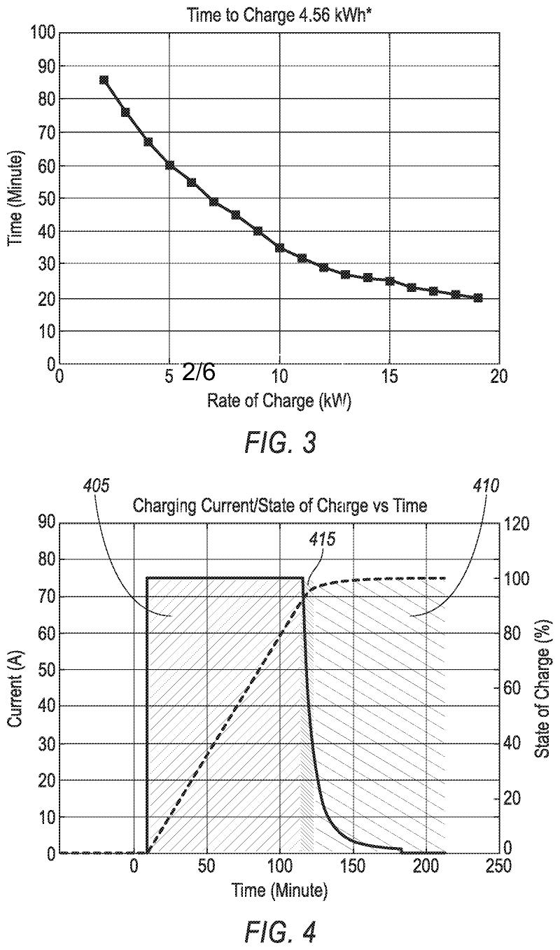

FIG. 3 illustrates an example graph showing the time to charge (minutes) versus the rate of charge (kW) to charge 4.56 kWh energy into a battery with 7.6 kWh capacity. The example rate of charge for a battery for one representative vehicle is illustrated to charge from 20-80% SOC of a 7.6 kWh battery. The slower the rate of charge, the longer that the battery 170 takes to charge.

FIG. 4 illustrates an example graph showing current (A) and SOC (%) versus time (minutes) for an example charging strategy of one example vehicle. As illustrated in FIG. 4, charging speed is generally faster when the SOC is low and decreases or stays constant when the SOC reaches a certain point. FIG. 4 illustrates that the percentage of energy in the battery increases as time increases. A fast charging range 405 and a slow charging range 410 may be identified by comparing the SOC and the current. During the fast charging range 405, the battery 170 may charge at a relatively fast rate compared to the rate during the slow charging range 410. Thus, to optimize charging time, charging a battery in the fast charging range 405 may be preferable. The fast charging range 405 and slow charging range 410 may be separated by a threshold state of charge 415 where the rate of charge decreases at this state of charge. In the example shown in FIG. 4, the threshold state of charge is approximately 90%. This is an example and may vary from battery to battery.

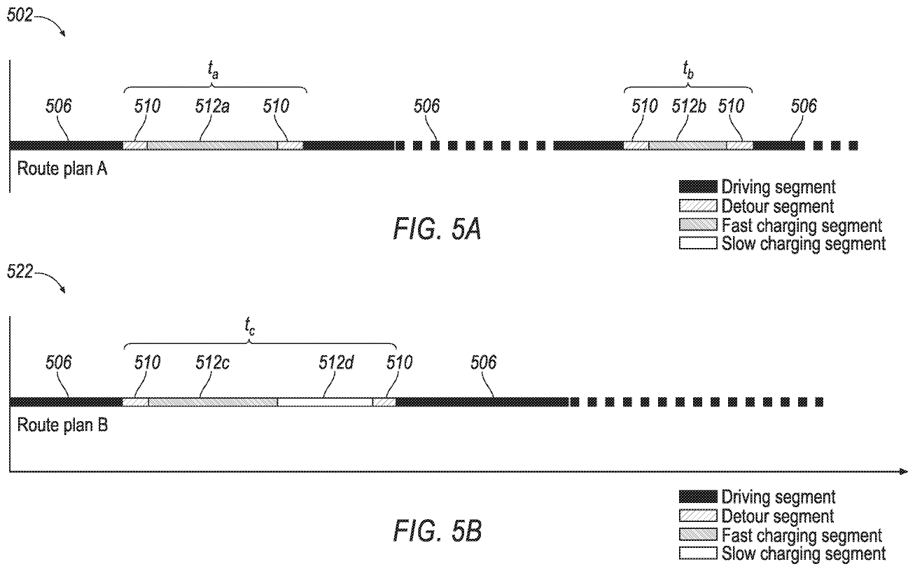

FIGS. 5A and 5B illustrate possible route plans available for the route 200 including the time allocated for possible vehicle recharging. FIGS. 5A and 5B each illustrate possible navigation and charge strategies and options from which the long-range navigation system 172 may select. In the route examples of FIGS. 5A and 5B, the route may require more energy than the battery 170 can provide based on a current state of charge, thus requiring at least one stop along the route for charging. Thus, the route 200 may be modified to include charging segments. The charging segments 512 may be classified as one of two types of segments, fast charging segments and slow charging segments. The fast charging segments may correspond to charging occurring during the fast charging range 405 of FIG. 4 where the battery 170 may charge at a faster rate than that during the slow charging range 410. Typically, recharging of a vehicle battery 170 includes recharging the battery to full capacity. However, while the battery may charge quickly at first, towards the end of the charging, the charging rate may decrease as the state of charge increases as illustrated and described with respect to FIG. 4. Thus, charging a battery to full capacity may include a fast charging segment followed by a slow charging segment.

The route 200 may be modified to include at least one charge stop 210. The charge stop 210 may include a first number of shorter charging stops for recharging the battery at a first rate (i.e., in the fast charging range 405) to a first state of charge less than a maximum state of charge or the threshold state of charge 415. The route 200 may also include a second number of longer charging stops for recharging the battery at a second rate (i.e., in the slow charging range 410) to a second state of charge higher than the first state of charge, wherein the first rate is faster than the second rate and the first and second number of charging stops are selected to minimize combined charging time of the at least one charging stop.

FIG. 5A illustrates an example first route plan 502. The first route plan 502, for example purposes only, breaks a trip or route 200 down into multiple segments. Each segment may be responsible for a certain amount of time along the route 200. For example, the first route plan 502 may include a plurality of driving segments 506. The driving segments 506 may make up the time that the vehicle 102 is traveling along the route 200. The first route plan 502 may include detour segments 510. The detour segments 510 may make up the time that the vehicle 102 is driving to a charging station 212.

The route plan 502 may also include charging segments 512. The route plan 502 may include charging segments of varying durations. A first charging segment 512a may be considered a “fast charging time” where the vehicle battery 170 charges quickly, but likely does not complete charging of the battery 170. The first charging segment 512a may correspond to a first time tₐ. A second charging segment 512b may be similar. The second charging segment 512b may be associated with a second time t_{b}. While the first and second charging segments 512a, 512b may differ in duration, each may be considered a “shorter” and “faster” charging segment when compared to a segment that fully charges the battery 170. While the first and second time segments 512a, 512b, may both be considered fast charging segments, the first time and second time may differ.

FIG. 5B illustrates another example route plan 522. A second route plan 522, for example purposes only, may also include multiple segments such as driving segments 506, detour segments 510, etc. The second route plan 522 may include a third charging segment 512c. A fourth charging segment 512d may be included immediately following the third charging segment 512c. In this option, the third charging segment 512c and the fourth charging segment 512d may be combined to create one, longer charging time as compared to the two shorter charging times of the first route plan 502. The fourth charging segment 512d may be considered a “slow charging segment” since the state of charge of the battery 170 has met the threshold at which the charging rate has slowed. Overall the combined charging segment of the third and fourth charging segments 512c, 512d, may also be referred to as a slow charging segment since the average rate of charge is much lower than that of a charging segment operating before the threshold in the fast charging range 405.

The long-range navigation system 172 may determine a total charge time for each of the route plans 502, 522. For example, the charging time for the first route plan 502 may include the charging segments 512 and detour segments 510. Thus, for the first route plan 502, the charging time may be t₁=tₐ+t_{b}.

For the second route plan 522, the charging time may be t₂=t_{c}. The navigation system 172 may then compare t₁ and t₂ to determine which of the two route plans have the shortest charging time.

Notably, each charging segment 512 may be associated with an energy. That energy may be the energy gained during the respective charging segments. For example, the first charging segment 512a may be associated with a first energy, the second charging segment 512b may be associated with a second energy, and so on. Each route plan may provide enough energy to complete the route 200. Thus, the energy of the routes may be fixed based on the required energy needed to complete the route. When comparing the routes to one another, the amount of energy acquired during the charging segments may be approximately the same sum total for each route. Thus, while the navigation system 172 may take into consideration the energy associated with each charging segment when selecting between the route plans 502, 522, the selection of the route is based on the charging time.

If t₁>t₂, and both of the route plans 502, 522 are presumed to acquire enough energy to complete the route, then the second route plan 522 may be selected by the navigation system 172. In this example, one longer charging segment may take less time overall than two shorter charging segments.

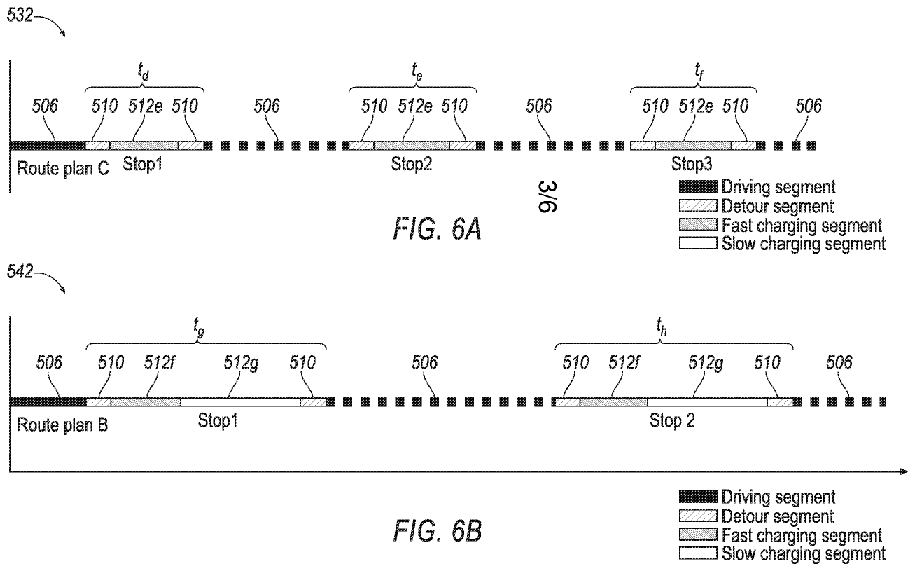

FIGS. 6A and 6B may illustrate additional possible route plans available for the route 200 including the time allocated for possible vehicle recharging. FIGS. 6A and 6B each illustrate possible navigation and charge strategies and options upon which the long-range navigation system 172 may select from. In the route examples of FIGS. 5A and 5B, the route may require more energy than the battery 170 can provide, thus requiring at least one stop along the route for charging. Unlike the examples in FIGS. 5A and 5B, the routes associated with FIGS. 6A and 6B may require more than one full battery recharge to complete the route.

FIG. 6A illustrates an example third route plan 532. The third route plan 532, for example purposes only, breaks a trip or route 200 down into multiple segments, similar to FIGS. 5A and 5B. For example, the third route plan 532 may include a plurality of driving segments 506, detour segments 510, and charging segments 512. The third route plan 532 includes multiple fifth charging segments 512e. Each of these charging segments 512e have equal, near equal, or at least substantially similar charging times, varying by only a few minutes of each other. Similar to the first route plan 502, these segments may be considered fast charging segments. Each may also be associated with detour segments 510.

FIG. 6B illustrates another example route plan 542. The fourth route plan 542, for example purposes only, may also include multiple segments such as driving segments 506, detour segments 510, etc. The fourth route plan 542 may have sixth charging segments 512f (e.g., fast charging segments) and seventh charging segments 512g (e.g., slow charging segments) following each of the sixth charging segments 512f. In this option, one of each of the sixth charging segments 512f and the seventh charging segments 512g may be combined to create one, longer charging segment as compared to the two shorter charging segments of the first route plan 502.

The long-range navigation system 172 may determine a total charge time for each of the third and fourth route plans 532, 542. For example, the charging time for the third route plan 532 may include the charging segments 512 and detour segments 510. Thus, for the third route plan 532, the charging time may be t₃=t_{d}+tₑ+t_{f}. The charging time for the fourth route plan 542 may include the charging segments 512 and detour segments 510. Thus, for the fourth route plan 542, the charging time may be t₄=t_{g}+tₕ. The navigation system 172 may then compare t₃ and t₄ to determine which of the two route plans have the shortest charging time.

For example, if t₃<t₄, then the third route plan 532 may be selected by the navigation system 172. In this example, three shorter charging segments 512 may take less time than two longer ones.

Generally, the navigation system 172 may optimize the route 200 when the distance to the destination is greater than the current range of the battery 170. In some examples, the distance to empty (DTE) may also be considered in determining whether the distance to the destination is greater than the current DTE. When more than a full charging energy is needed during the trip, two or more short but fast charging stops may require less time than one full charging time period.

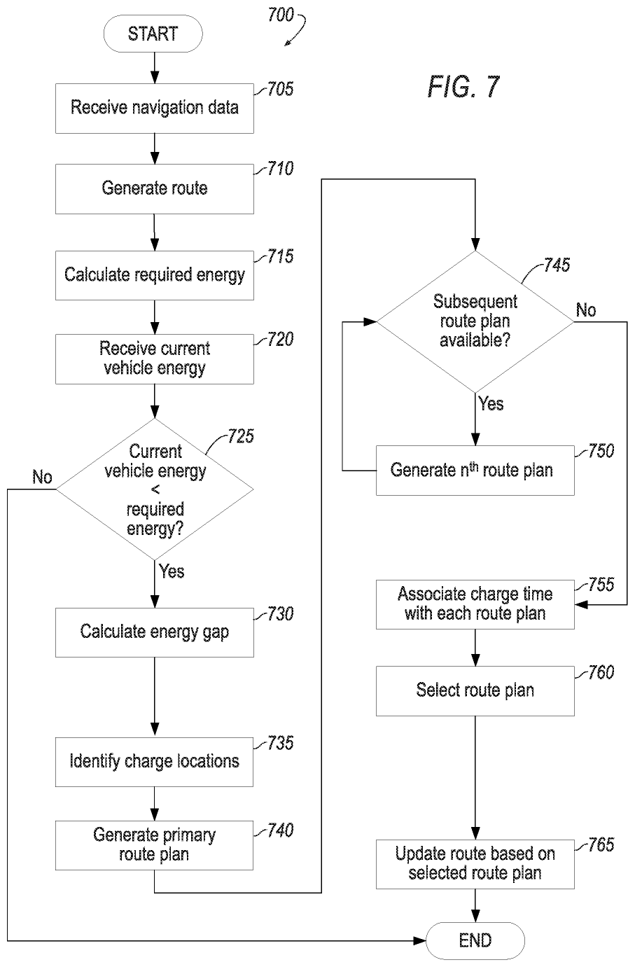

FIG. 7 illustrates an example process 700 for the navigation system 172. In one example, the process 700 may be carried out by the processor 106 or a controller. The processor 106 may be configured to carry out other vehicle processes, or the processor 106 may be a special purpose processor.

The process 700 may begin at block 705 where the processor 106 may receive navigation data. The navigation data may include the vehicle's current location and the destination location. As explained, the current location may be received from the GPS module 146. The destination may be received from user input at the HMI controls 136 via the display 138, or other mechanisms of receiving destination locations.

At block 710, the processor 106 may generate a default route 200 based on the navigation data. This route 200 may be a regular route that does not take into account any energy requirements for completing the route 200. This route 200 may be a route that includes a fastest and/or shortest route based on the navigation preferences of the user.

At block 715, the processor 106 may calculate the required energy needed for the trip. This may take into consideration the power needed to drive along the route 200 and may take into consideration a driver's driving style, expected delays due to traffic or weather, topographical and incline data along the route, predicted cabin climate, etc.

Next, at block 720, the processor 106 may receive a current SOC of the battery 170 for BEVs. The processor 106 may also receive the current fuel level for PHEVs (plug-in hybrid electric vehicles). The current SOC may indicate the current EV range. The fuel level may indicate the current distance to empty (DTE). These may be combined to indicate the current vehicle energy.

At block 725, the processor 106 may determine whether the current vehicle energy is less than the required energy. In the example of a BEV, the current vehicle energy may be the EV range. In a PHEV, the current vehicle energy may also take into consideration the current distance to empty. If the required energy exceeds the current vehicle energy, the process 700 may proceed to block 730. If not, the process 700 may end.

At block 730, the processor 106 may calculate the energy gap between the required energy and current vehicle energy.

Following this, at block 735, the processor 106 may identify one or more charge points 210 along the route 200 as possible locations of recharge of the battery 170. The processor 106 may also search for possible charging stations 212 within a predefined radius (e.g., 5 miles) of the route 200.

At block 740, the processor 106 may generate a primary route plan. The primary route plan may include at least one charge point 210 where the vehicle 102 may recharge the battery 170 to a full capacity. This route plan may be similar to the second route plan 522, or the fourth route plan 542. While the examples show one and two charge points, more than this may be included, especially in the case of longer trips. The route plan may take into consideration the locations of the charge points 210, and the detours required to make it to the respective charging stations 212.

Next, at block 745, the processor 106 may determine whether a subsequent route plan is feasible. That is, could another variation of a route that includes one or more charging points 210 be generated and still achieve the required energy to complete the route. This subsequent route differs from the first route. The processor 106 may determine whether there are additional potential charge points 210 along the route that could offer alternative charging locations. If another subsequent route plan is possible due to additional charge points 210 along the route, the process 700 may proceed to block 750. If not, the process 700 may proceed to 755.

Further, at block 750, the processor 106 may generate a subsequent, or n^{th}, route plan. The subsequent route plan(s) may focus on having charging segments that are considered the faster charging segments rather than just full capacity charging segments. As explained above, full capacity charging segments may include charging that charges the battery quickly, as well as segments that charge the battery slowly once a certain state of charge has been exceeded. For example, the battery may charge quickly from 20-80% SOC but slowly after 80%. In the example shown in FIG. 4, a battery 170 may charge slowly after the state of charge threshold of 90%. Thus, charging a battery to full capacity may take a substantial amount of time due to the slow charging segment. The subsequent route plan may identify charging strategies that include fast charging segments within the fast charging range 405 and avoid slow charging segments within the slow charging range 410.

The subsequent route plan, similar to the primary route plan, may take into consideration the location of possible charge points 210, and the detours required to make it to the respective charging stations 212. In this example, the subsequent route plan may differ from the primary route plan. The subsequent route plan may be similar to the first and third route plans 502, 532. The process 700 may proceed to block 745 until no further route plans may be generated.

At block 755, the processor 106 may calculate the charging time for each of the first and subsequent route plans.

Then at block 760, the processor 106 may select the route plan with the shortest charging time. Additionally or alternatively, the user may be provided with the option to select from one or more route plans via the user interface and display 138. The user may have a preference as to which stops or just in general as to the charging strategy and may prefer to select which alternative route to travel.

At block 765, the processor 106 may update the default route 200 to include the one or more charging stations 212 as indicated by the selected route plan as waypoints.

Thus, the selected route plan is used to update the route 200 with various charging locations to allow the vehicle to recharge and optimize the charging time.

Computing devices, such as the processor, controller, remote servers, remote devices, etc., generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An electrified vehicle, comprising:
a vehicle battery; and
a processor configured to:
receive map data and generate a route based on the map data; and
in response to a required vehicle energy to complete the route exceeding a current vehicle energy, modify the route to include at least one charging stop, wherein the at least one charge stop includes:
a first number of shorter charging stops for recharging the battery at a first rate to a first state of charge less than a maximum state of charge; and
a second number of longer charging stops for recharging the battery at a second rate to a second state of charge higher than the first state of charge, wherein the first rate is faster than the second rate and the first and second number of charging stops are selected to minimize combined charging time of the at least one charging stop.

2. The vehicle of claim 1, wherein the second number is zero and the first number exceeds the second number.

3. The vehicle of claim 2, wherein the charging time includes a length of time associated with charging of the battery and a length of time associated with a detour from the route to reach a charging station for the recharging of the battery.

4. The vehicle of claim 1, wherein the current vehicle energy is calculated based on a current state of charge.

5. The vehicle of claim 1, wherein the processor is further configured to locate potential charge points along the route based on the required energy.

6. The vehicle of claim 5, wherein the processor is further configured to identify charge stations within a predefined distance of the charge points along the route.

7. The vehicle of claim 1, wherein the charging time of each of the shorter and longer charging stops is based at least in part on a current state of charge of the battery.

8. A long-range navigation system for an electric vehicle, comprising:
a memory; and
a processor configured to:
receive map data and generate a route based on the map data, the route associated with a calculated required energy needed to complete the route; and
in response to the required energy exceeding a current vehicle energy, modify the route to include at least one charging stop to allow for recharging of a vehicle battery at a first rate, the first rate including a charge rate up to a threshold battery state of charge where the charge rate begins to decrease.

9. The system of claim 8, wherein the threshold battery state of charge is a state of charge at which the charge rate decreases as the state of charge increases.

10. The system of claim 8, wherein a charging time of each of the charging stops at the first rate is less than the charging time of a single longer charging stop at a second rate, wherein the first rate is faster than the second rate.

11. The system of claim 10, wherein the charging time includes a length of time associated with charging of the battery and a length of time associated with a detour from the route to reach a charging station for the recharging of the battery.

12. The system of claim 10, wherein the charging time of each of the charging stops is based at least in part on a current state of charge of the battery at the associated charging stop.

13. The system of claim 8, wherein the current vehicle energy is calculated based on a current battery state of charge and a current fuel level.

14. The system of claim 8, wherein the processor is further configured to locate potential charge points along the route based on the required energy.

15. The system of claim 14, wherein the processor is further configured to identify charge stations within a predefined distance of the charge points along the route.

16. A method for recharging an electric vehicle along a route, comprising:
receiving map data and generate a route based on the map data; and
modifying, in response to a required energy required for completing the route exceeding a current energy, the route to include at least one charging stop along the route, the charging stop including at least one of a shorter charging stop for recharging of a vehicle battery at a first rate of charge less than a maximum state of charge and a second rate to a second state of charge higher than the first state of charge.

17. The method of claim 16, wherein a combined charging time of the at least one short charging stop is less than a charging time of the at least one longer charging stop.

18. The method of claim 16, further comprising locating potential charge points along the route based on the required energy along the route.

19. The method of claim 18, further comprising identifying charge stations within a predefined distance of the charge points.

20. The method of claim 16, wherein charging time of each of the charging stops is based at least in part on a current state of charge of the battery.
